(19) United States
(12) Patent Application Publication
(10) Pub. No.: US 2020/0214517 A1
(43) Pub. Date: Jul. 9, 2020

(54) CLEANER

(71) Applicant: MAKITA CORPORATION, Anjo-shi, Aichi (JP)

(72) Inventors: Akinori ITO, Anjo-shi (JP); Yasutoshi SHINMA, Anjo-shi (JP)

(73) Assignee: MAKITA CORPORATION, Anjo-shi, Aichi (JP)

(21) Appl. No.: 16/638,047

(22) PCT Filed: Jul. 18, 2018
(86) PCT No.: PCT/JP2018/026867

§ 371 Date: Feb. 10, 2020

(30) Foreign Application Priority Data
Aug. 25, 2017 (JP) 2017-162564

(51) Int. Cl. A47L 5/24; A47L 9/24; A47L 9/00; A47L 9/06; A47L 9/08; A47L 7/00; B60S 3/00

(52) U.S. Cl. CPC A47L 5/24; A47L 9/248; A47L 9/0027; A47L 9/0673; B60S 3/008; A47L 9/0693; A47L 7/0076; A47L 9/0036; A47L 9/08

(57) ABSTRACT

A main unit and a hose of a cleaner may be connected via a connecting portion constituted by a ball joint. The hose may be wound around a hose holding portion and stored at a front end storage so that it can be held to the main unit in a compact manner.

### CROSS-REFERENCE TO RELATED APPLICATIONS

The present application is a U.S. National Phase entry of, and claims priority to, PCT Application No. PCT/JP2018/026867, filed Jul. 18, 2018, which claims priority to Japanese Patent Application No. 2017-162564, filed Aug. 25, 2017, both of which are incorporated herein by reference in their entireties for all purposes.

### BACKGROUND

The present invention relates to a cleaner used, for example, for cleaning a cabin of a motor vehicle.

Some cleaners can be used without being connected to, for example, an AC power source by using a rechargeable battery, so as to be portable. Such a cleaner can be more easily carried around by further compactly attaching a hose and an attachment(s) to the cleaner main unit. Accordingly, the storage space for the cleaner can be reduced when stored in a motor vehicle. Japanese Laid-Open Patent Publication No. 2010-75471 describes a structure in which a hose can be wound around and held by a main unit of a cleaner.

However, the hose of the cleaner having the structure for winding and holding the hose as described in Japanese Laid-Open Patent Publication No. 2010-75471 may be easily damaged. This is partly due to the hose being greatly curved at a connecting portion, particularly between the hose and the main unit, when it is wound up. When the connecting portion between the hose and the main unit is made to be firm in order to improve its durability, the hose is less easily bent, thereby deteriorating the compactness of the entire cleaner when the hose wound and held in place.

An object of the present disclosure is to enable a hose to be wound around and held by a main unit in a compact manner, without deteriorating the durability of the hose at a connecting portion to the main unit.

### BRIEF SUMMARY

The first embodiment is a cleaner including a motor, a fan rotated by the motor, a main unit for accommodating the motor and the fan, a hose as a flow passage for suction air generated by the fan into the main unit, and a battery attachment portion, to which a rechargeable battery can be removably attached. In the first embodiment, the hose and main unit are connected to each other at the connecting portion via a ball joint. In the first embodiment, the hose is provided such that it can be wound around the main unit. In the first embodiment, at least one part between the connecting portion and a front end of the hose is (are) held by the main unit in an attachable/removable manner.

According to the first embodiment, the rotational degree(s) of freedom at the connecting portion of the hose is (are) enhanced by connecting the hose and the main unit using the ball joint. Therefore, according to the first embodiment, since the load applied to the hose at the connecting portion at the main unit can be reduced when the hose is wound around the main unit, the hose can be wound around the main unit in a compact manner. Further, according to the first embodiment, since at least one part between the connecting portion and the front end of the hose wound around the main unit is held by the main unit, the hose can be held in a compact manner, with the hose being wound around the main unit.

The second embodiment is the cleaner according to the first embodiment, in which an axis of the hose at the connecting portion is inclined with respect to an axis of a motor shaft of the motor.

According to the second embodiment, the hose can be more easily held by being wound around the main body. Further, according to the second embodiment, the length of the main unit in an axial direction of the motor shaft can be reduced.

The third embodiment is the cleaner according to the first or second embodiment, in which the hose can be stored with the hose wound around the main unit ahead of the fan.

According to the third embodiment, the hose can be stored at a front portion of the main unit in a compact manner. Accordingly, the cleaner can be more easily carried with the hose wound around the main unit.

The fourth embodiment is the cleaner according to the third embodiment, in which a front end of the hose is stored by being held by the main unit in a position side-by-side with the connecting portion of the hose.

According to the fourth embodiment, the connecting portion and the front end of the hose can be held by the main unit in a compact manner, well-balanced in a side-by-side direction (e.g., the left-right direction).

The fifth embodiment is the cleaner according to any one of the first to fourth embodiments, in which an attachment can be attached to or removed from the front end of the hose. In the fifth embodiment, the attachment can be removed from the hose and stored by the main unit.

According to the fifth embodiment, the attachment suitable for cleaning a spot can be quickly attached to the front end of the hose and removed from the hose so as to be quickly stored in the main unit.

The sixth embodiment is the cleaner according to the fifth embodiment, which is provided with a brush surface at a suction port end face of the attachment. According to the sixth embodiment, auxiliary brushes are provided on an outside of the attachment and located at a place corresponding to a downstream suction air side of the brush surface.

According to the sixth embodiment, dust adhered to seats, etc., of a motor vehicle can be swept out by the brush surface of the attachment and be inhaled. Further, according to the sixth embodiment, the dust accumulated in small gaps, for example, seams and grained grooves, etc., of the motor vehicle, that were not possible to be swept out with the brush surface can instead be swept out with the auxiliary brush(es).

The seventh embodiment is the cleaner according to the fifth embodiment, which is provided with a plurality of projections at the suction port end face of the attachment. These projections extend in a direction opposite to a suction direction of the suction air. In the seventh embodiment, the plurality of the projections are aligned with one another on the suction port end face.

According to the seventh embodiment, the suction port end face of the attachment may come close to a location where the dust is adhered to, for example, a mat of the motor vehicle. This location is accordingly surrounded by the plurality of projections. Herewith, the strong suction air flows through a narrow gap between the plurality of the projections, as well as between the mat, for example, and the suction port end face, such that the dust can be easily inhaled by this strong suction air.

The eighth embodiment is the cleaner according to the fifth embodiment, in which the attachment is a nozzle having an extended form in the suction direction of the suction air. In the eighth embodiment, the front end of the nozzle is provided with a brush. In the eighth embodiment, the brush is rotatably attached to the nozzle.

According to the eighth embodiment, the front end of the nozzle is able to reach narrow and intricate locations, such as end portions of door handles or a windshield of a motor vehicle, for example, by using an elastic nozzle. Thereby, the locations normally difficult to clean can be cleaned by using the attachment. Further, according to the eighth embodiment, locations with small components, such as an instrument panel of a motor vehicle, can be cleaned using the aid of the brush attached to the front end of the nozzle. Furthermore, according to the eighth embodiment, the brush can be rotated relative to the front end of the nozzle in accordance with the desired location to be cleaned and can accordingly be adapted to clean various intricate locations.

The ninth embodiment is a cleaner according to any one of the first to eighth embodiments, in which a blower nozzle having a hose-shape can be attached to or removed from an air outlet of the main unit. The ninth embodiment serves as a blower when the blower nozzle is attached.

According to the ninth embodiment, it is possible to add a function as a blower to the cleaner by utilizing its exhaust air. The convenience of the cleaner can thereby be enhanced.

### BRIEF DESCRIPTION OF THE DRAWINGS

FIG. 1 is a perspective view of an entire cleaner according to the present embodiment. This figure illustrates the present embodiment of the cleaner as viewed from the front-left side.

FIG. 2 is a perspective view of the entire cleaner according to the present embodiment. This figure illustrates the present embodiment of the cleaner as viewed from the rear-right side.

FIG. 3 is a top view of the entire cleaner according to the present embodiment.

FIG. 4 is a vertical cross-sectional view of the cleaner according to the present embodiment, taken along line (IV)-(IV) of FIG. 3.

FIG. 5 is a perspective view of an entire seat nozzle according to the present embodiment.

FIG. 6 is a view of the entire seat nozzle according to the present embodiment as viewed from a suction port direction.

FIG. 7 is a lateral view of the entire seat nozzle according to the present embodiment.

FIG. 8 is a front view of an entire mat nozzle according to the present embodiment.

FIG. 9 is a cross-sectional view of the mat nozzle according to the present embodiment, taken along line (IX)-(IX) of FIG. 8.

FIG. 10 is a perspective view of an entire long sash nozzle according to the present embodiment.

FIG. 11 is a lateral view of the entire long sash nozzle according to the present embodiment.

FIG. 12 is a lateral view of the entire long sash nozzle according to the present embodiment.

FIG. 13 is a cross-sectional view of the long sash nozzle according to the present embodiment, taken along line (XIII)-(XIII) of FIG. 11.

FIG. 14 is a perspective view of an entire brush attachment according to the present embodiment.

FIG. 15 is a vertical cross-sectional view of the entire brush attachment according to the present embodiment.

FIG. 16 is a view of the entire brush attachment according to the present embodiment from the suction port direction.

FIG. 17 is a perspective view of an entire blower nozzle according to the present embodiment.

FIG. 18 is a vertical cross-sectional view of the entire blower nozzle according to the present embodiment.

FIG. 19 is a perspective view of an entire second mat nozzle according to the present embodiment.

FIG. 20 is a perspective view of an entire second mat nozzle according to the present embodiment from the suction port side.

FIG. 21 is a vertical cross-sectional view of the second mat nozzle according to the present embodiment.

FIG. 22 is a perspective view of an entire long rubber nozzle according to the present embodiment.

FIG. 23 is a side view of an entire instrument panel nozzle according to the present embodiment, with the suction port opened in a longitudinal direction.

FIG. 24 is a front view of the entire instrument panel nozzle according to the present embodiment, with the suction port opened in the longitudinal direction.

FIG. 25 is a side view of the entire instrument panel nozzle according to the present embodiment, with the suction port opened in a direction orthogonal to the longitudinal direction.

FIG. 26 is a front view of the entire instrument panel nozzle according to the present embodiment, with the suction port opened in the direction orthogonal to the longitudinal direction.

FIG. 27 is a vertical cross-sectional view of the entire instrument panel nozzle according to the present embodiment, taken along line (XXVII)-(XXVII) of FIG. 24.

FIG. 28 is a vertical cross-sectional view of the entire instrument panel nozzle according to the present embodiment, taken along line (XXVIII)-(XXVIII) of FIG. 26.

### DETAILED DESCRIPTION

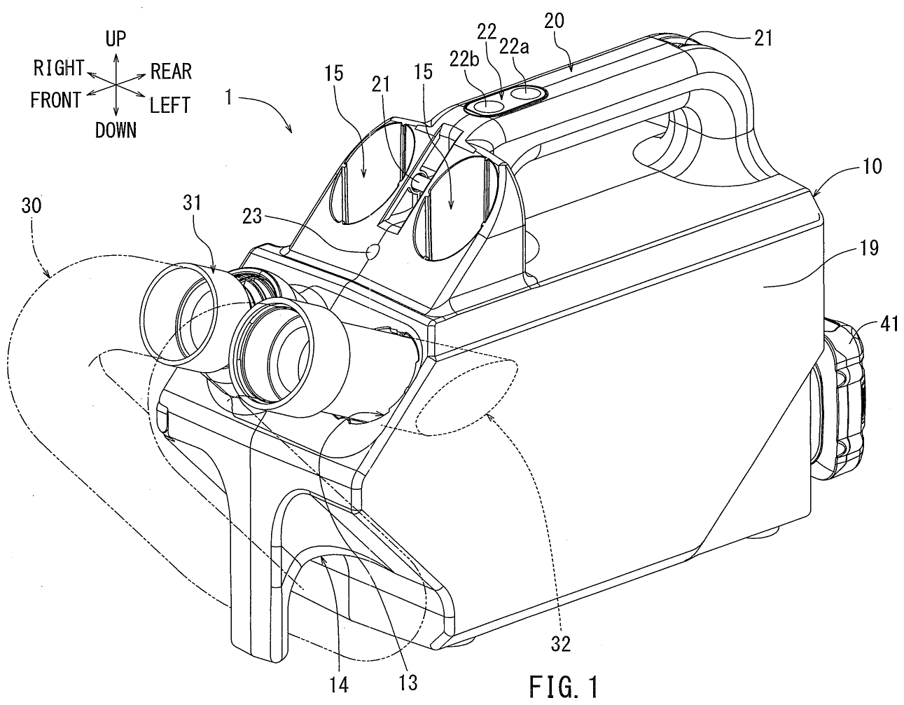

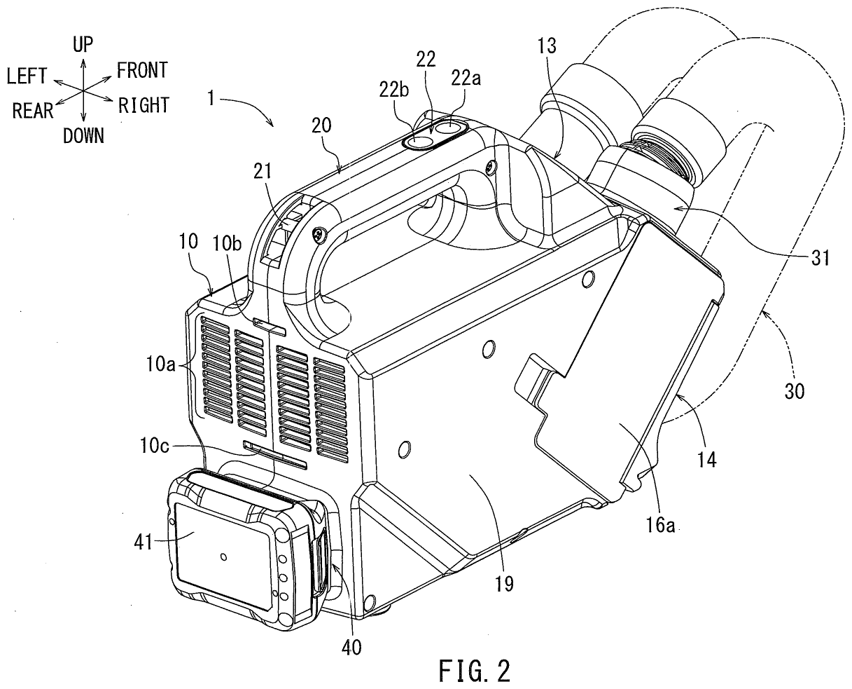

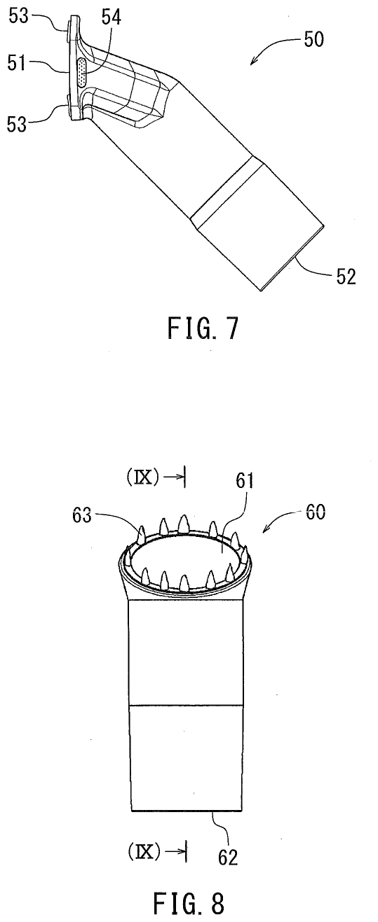

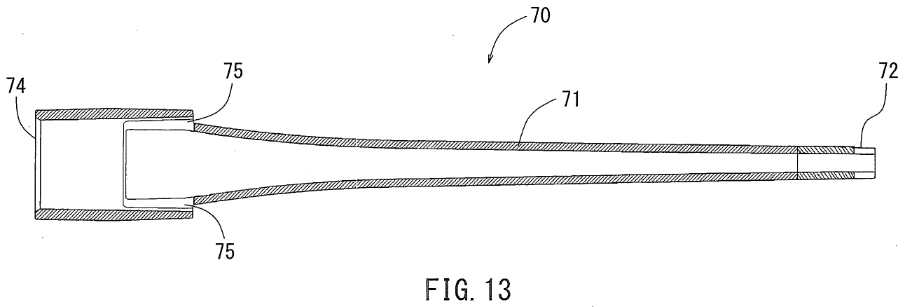

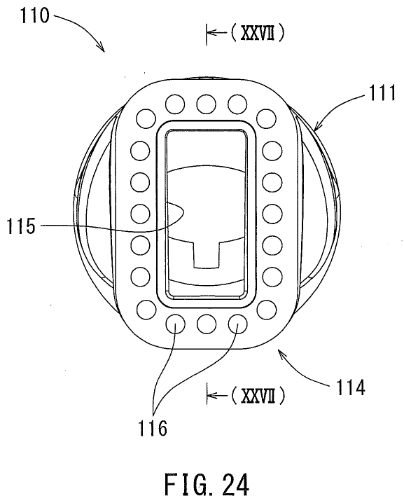

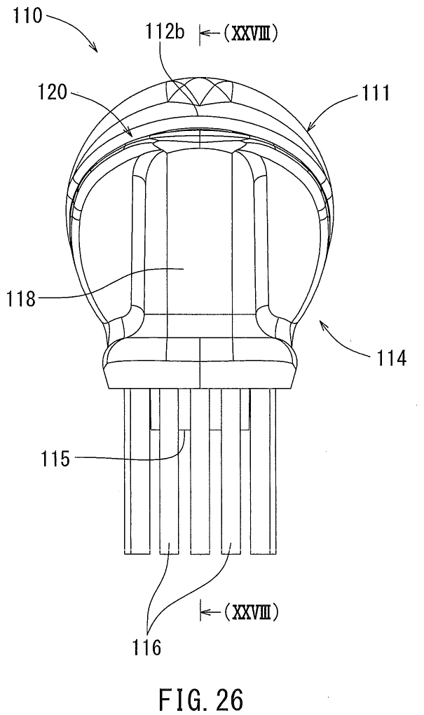

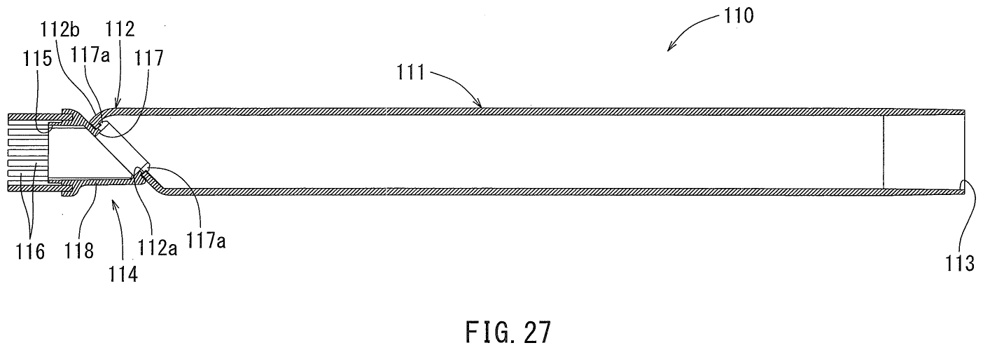

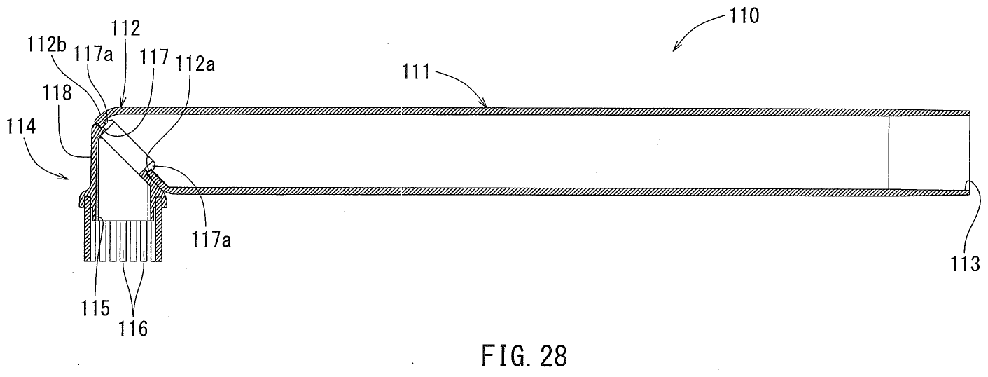

Hereinafter, embodiments will be described with reference to FIG. 1 to FIG. 28. As shown in FIG. 1 and FIG. 2, a cleaner 1 of the present embodiment may include a main unit 10 accommodating a motor 11 and a fan 12, a handle 20 provided at an upper part of the main unit 10, a hose 30 attached to the main unit 10, and a battery attachment portion 40 configured to detachably hold a rechargeable battery serving as a power source of a main unit housing 19, the main housing unit 19 having a substantially rectangular box shape. In the following description, the up-down, left-right, and front-rear directions are, as shown in the drawings, determined on the basis when the user grasps the handle 20, such that the hose 30 is positioned in front of the main unit 10.

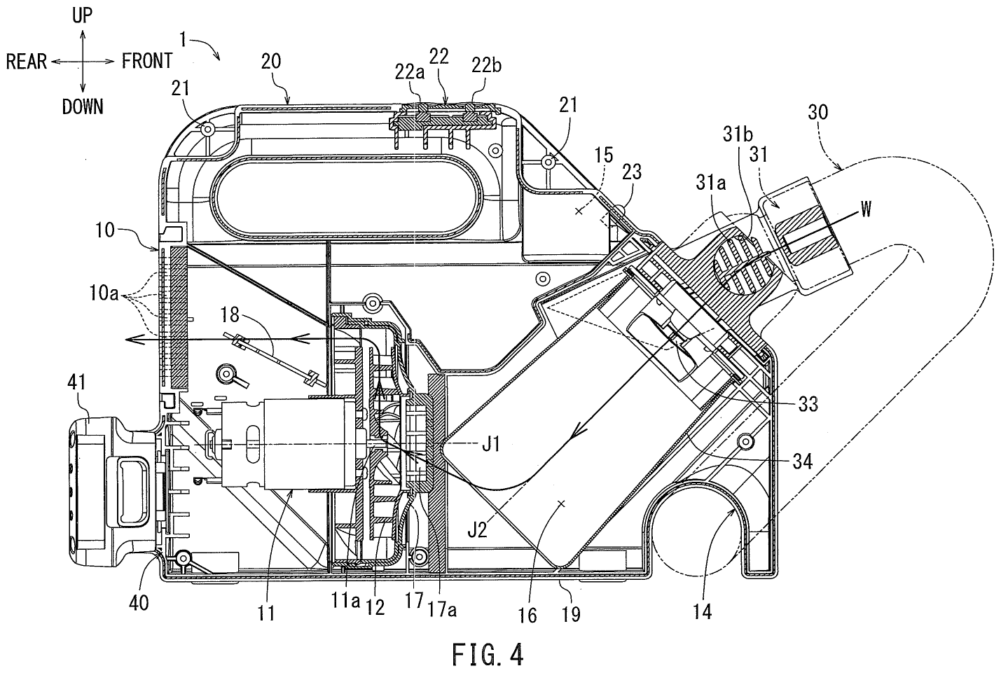

As shown in FIG. 4, the flexible hose 30 may be connected to a front portion of the main unit 10 via a connecting portion 31. The hose 30 may be provided at the connecting portion 31 so as to extend substantially diagonally, in the forward and upward directions. The connecting portion 31 may be a ball joint. Specifically, the connecting portion may include a ball portion 31a, which may be spherical, on the side of the hose 30 and a ball receiving portion 31b, which may be a spherical recess, on the side of the main unit 10. The ball portion 31a may be inclinably (swingably) provided in all directions, within predetermined angle ranges with respect to a hose axis J2 (an axis of the ball receiving portion 31b), when it is fitted into the spherical recess of the ball receiving portion 31b. A cylindrical or spherical hole penetrates through the inside of the ball portion 31a, which cannot be seen in the figure. This hole serves to communicate between the hose 30 and a dust bag attachment port 33, which will be described later. The dust bag attachment port 33 is fixed to be generally aligned with the hose axis J2.

As shown in FIG. 1, a front end 32, which may be formed at the end of the hose 30, may serve as a suction port for the suction air generated by a fan 12 (described later). A separately provided attachment may be attached to the front end 32.

As shown in FIG. 1 and FIG. 2, a groove extending in a left-right direction of the main unit 10 may be provided at a lower front portion of the main unit 10. This groove is provided as a hose holding portion 14. The cross-section of the hose holding portion 14 in its extending direction may be configured to have generally a circular shape with a slightly greater diameter than the outer diameter of the hose 30. The hose 30 can be held in the main unit 10 by winding the hose 30 in a direction from the connecting portion 31 so that it goes around the main unit 10 along the hose holding portion 14.

As shown in FIG. 1 and FIG. 2 and FIG. 4, a front end storage portion 13 may be provided in front of the main unit 10 and in a position aligned side-by-side with the connecting portion 31, in the left-right direction. The front end storage portion 13 may be configured as substantially a circular hole having a slightly greater diameter than an outer diameter of the front end 32 of the hose 30. The hole of the front end storage portion 13 may extend diagonally, in the rearward and downward directions. The front end storage portion may extend along the side of the main unit 10 and generally parallel to the hose extending direction of the connecting portion 31. The front end 32 can be stored by being inserted in the front end storage portion 13, while the entire hose 30 is held at the main unit 10, after the hose 30 is wound around the hose holding portion 14.

As shown in FIG. 4, a dust bag storage 16 may be provided within the front side of the main unit 10, behind a dust bag attachment port 33 in communication with the hose 30 via the connecting portion 31. A separately provided dust bag 34 may be attached to the dust bag attachment port 33. The attached dust bag 34 may be stored in the dust bag storage 16. The dust bag 34 may be attached or removed by opening a storage cover 16a, an embodiment of which is shown in FIG. 2. The dust bag attachment port 33 may include a check valve upstream of the suction air, on the side of the hose 30. This check valve serves to prevent dust from blowing back toward the side of the hose 30 due to backflow of the suction air.

As shown in FIG. 4, a motor 11 may be disposed substantially at the center of the main unit 10. The motor 11 may be arranged such that an axis of the motor shaft 11a (motor axis J1) generally extends in a front-rear direction. The motor axis J1 and a hose axis J2 are inclined with respect to one another, as can be seen from the viewpoint of FIG. 4. Further, the motor axis J1 and the hose axis J2 may not intersect each other. A fan 12 may be attached at a front end of the motor shaft 11a. The fan 12 may be disposed behind the dust bag storage 16. As the motor shaft 11a is driven to be rotated, the fan 12 also rotates together with the motor shaft 11a. A fan cover 17 may be provided at a front face of the fan 12. The fan cover 17 may be provided with air vents 17a for allowing the suction air to flow from the dust bag storage 16 side to the side of the motor 11.

As shown in FIG. 4, a plurality of air outlets 10a may be provided at a rear end face of the main unit 10. A controller 18 may be provided in front of the air outlets 10a, and above the motor 11, within the main unit 10. The controller 18 may be provided with a control circuit comprising a microcomputer for controlling the drive of the motor 11, a drive circuit comprising a FET for switching the current of the motor 11, and an automatic stop circuit for detecting the power supply condition of the battery 41 (described later) and for blocking power supply to the motor 11 so as not to be brought into an over discharge or overcurrent condition in response to the detected result.

The suction air flows from the front side to the rear side within the main unit 10 as the fan 12 rotates. The suction air caused to flow by the fan 12 flows as indicated by the arrow W in FIG. 4, as will be described below. The suction air flows from the front end 32 of the hose 30, serving as a suction port, within the hose 30 in the direction toward the connecting portion 31. The suction air then flows through the connecting portion 31, into the dust bag attachment port 33, and then into the dust bag 34 stored inside the dust bag storage 16. The suction air, without the dust that was captured in the dust bag 34, flows through the vent port 17a of the fan cover 17 toward the fan 12. The air flowing behind the fan 12 flows toward the air outlets 10a and is discharged outside the main unit 10. The air flowing from behind the fan 12 toward the air outlets 10a also serves as cooling air for cooling the motor 11 and/or controller 18.

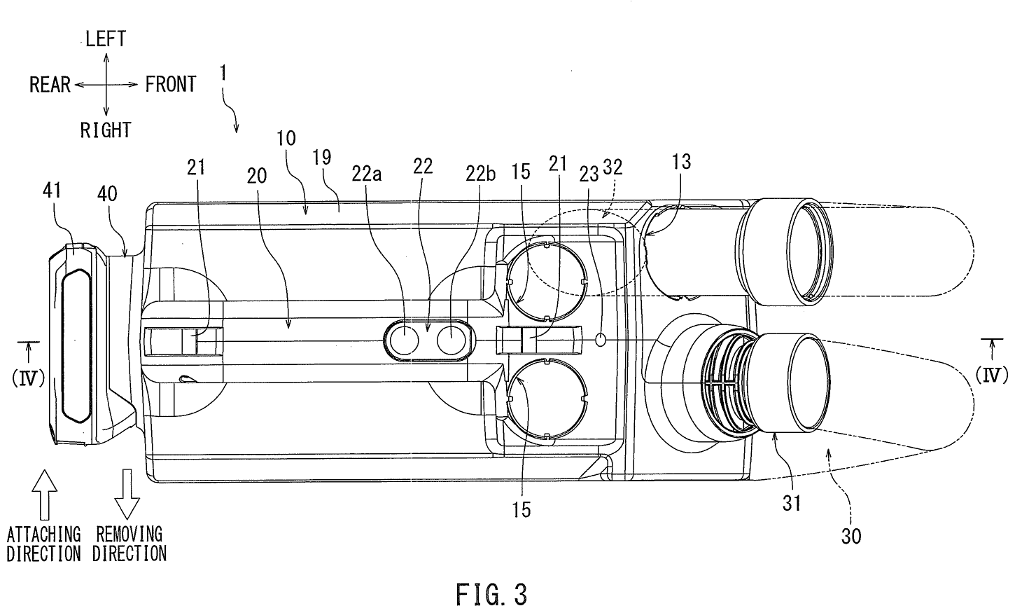

A battery attachment portion 40 may be provided at the rear end of the main unit 10. The battery attachment portion 40 may further be provided below the air outlets 10a. A battery 41, which may be a rechargeable lithium ion battery of 10.8V output, is configured so that it may be slidably moved so that it can be attached to or removed from the battery attachment portion 40. More specifically, as shown in FIG. 3, the battery 41 can be attached to the battery attachment portion 40 by slidably moving the battery 41 from the right side of the battery attachment portion 40 in the left direction, in a posture with the attachment surface of the battery 41 oriented forward. Further, the battery 41 can be removed from the battery attachment portion 40 by slidably moving the battery 41 attached to the battery attachment portion 40 in the right direction. The battery 41 attached to the battery attachment portion 40 supplies power to the motor 11 and controller 18.

As shown in FIG. 1 and FIG. 2, a handle 20 may be generally loop shaped and extend in the front-rear direction. The handle 20 may be provided on the upper side of the main unit 10. The main unit 10 may be a rectangular box shape. The user can hold the cleaner 1 to work or carry the cleaner by grasping the handle 20. Hook attachment portions 21 may be provided at both front and rear ends of the upper part of the handle 20, respectively. The cleaner 1 can be used and transported while wearing it on one's shoulder by inserting a separately prepared shoulder strap through the hook attachment portions 21.

A switch panel 22 may be provided on the upper front part of the handle 20. An OFF button 22a and a mode switching button 22b, in form of a push button, may be provided on the switch panel 22. The OFF button 22a and the mode switching button 22b may be arranged so that a user can operate the buttons while grasping the loop portion of the handle 20. The OFF button 22a and the mode switching button 22b may be electrically connected to the controller 18. The power source is turned off, for instance in order to stop driving the motor 11, by a pushing operation of the OFF button 22. The driving of the motor 11 is changed between different modes, with the power source being turned on, by a push operation of the mode switching button 22b. More specifically, when the mode switching button 22b is pushed once, while the power source is turned off, the motor 11 is driven in a “strong mode” with great power output. When the mode switching button 22b is pushed an additional time to operate, the mode will be switched to a “powerful mode” producing a greater power output. When the mode switching button 22b is pushed to operate once more again, the mode will be switched to a “normal mode” having a reduced power output and power consumption. Thereafter, each time the mode switching button 22b is additionally pushed to be operate, the mode will sequentially be switched in the order of the above-described three modes.

A battery shortage notification lamp 23 may be provided on the front face of the handle 20. A user is notified of the remaining charge of the attached battery 41 in accordance with the illumination condition of the battery shortage notification lamp 23.

Two attachment storages 15 capable of storing attachments (described later) may be provided on the front face of the handle 20. The attachment storages 15 may be configured as holes with openings extending diagonally, in the frontward and upward directions, the holes extending toward the inside of the main unit 10.

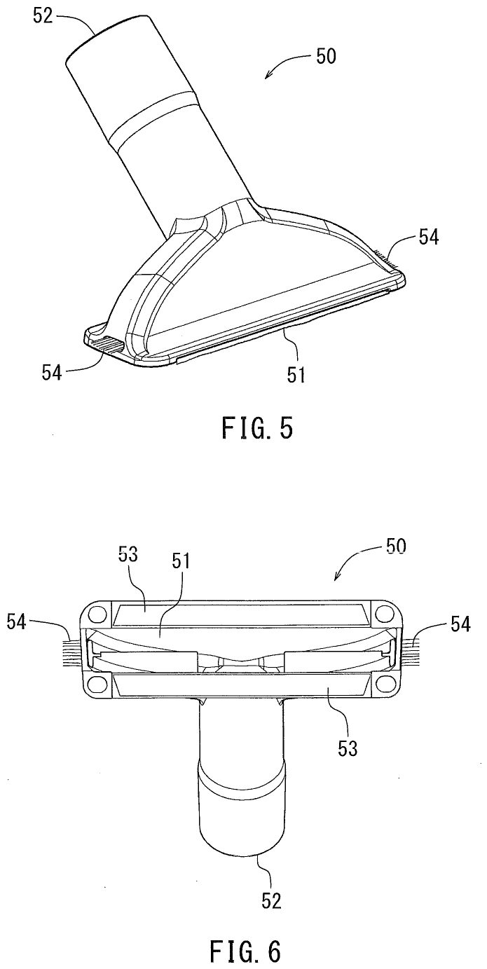

Hereinafter, an embodiment of a seat nozzle 50 attachable to the front end 32 of the hose 30 will be described with reference to FIG. 5 to FIG. 7. The seat nozzle 50 corresponds to one embodiment of an attachment configured to be connected to the hose 30. The seat nozzle 50 may be provided with a cylindrical attachment port 52, which can be engaged with and attached to the outer peripheral portion of the front end 32 of the hose. The seat nozzle 50 may also be provided with a suction port 51 configured to be brought in contact with work surfaces, such as a seat of a motor vehicle. The suction port 51 may be structured as an opening having a rectangular shape and may be provided with lint brushes 53 at opposite end faces so as to extend along the longitudinal direction of the suction port 51. The lint brushes 53 may be provided such that a nap of the lint brushes 53 is raised due to friction along the brush surface in one direction and laid down due to friction acting in a direction opposite to the one direction. In the present embodiment, the lint brushes 53 are each arranged such that the nap of the respective lint brush 53 is raised when the applied friction is in a direction relatively away from the suction port 51, and is laid down when the applied friction in a direction relatively approaching to the suction port 51. Dust is captured by the lint brushes 53 when the opening surface of the suction port 51 is brought in contact with the work surface, such as a seat of a motor vehicle, and is moved along the work surface. The captured dust slips off the lint brushes 53 when the nap of the lint brush 53 is laid down. Since the slipping off direction of the dust from the lint brushes 53 is determined respective of its location on the side of the suction port 51, the dust can be efficiently inhaled into the suction port 51.

The seat nozzle 50 may be provided with a pair of auxiliary brushes 54 on a side of the suction port 51 such that it is generally located downstream (attachment port 52 side) of the suction air from the abutment surface of the suction port 51 and the lint brushes 53 with the work surface. The pair of the auxiliary brushes 54 may be provided on the seat nozzle 50 (toward an attachment port 52 side) so as to extend outward from both longitudinal sides of the suction port 51. The auxiliary brushes 54 can be used to sweep out dust accumulated in spots, such as gaps, for example, seams and grained grooves of the seat, where the dust cannot be easily swept out using the lint brushes 54.

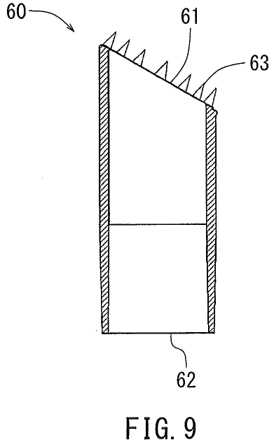

Hereinafter, an embodiment of a mat nozzle 60 configured to be attachable to a front end 32 of a hose 30 will be described with reference to FIG. 8 to FIG. 9. The mat nozzle 60 may correspond to another embodiment of the attachment connected to the hose 30. The mat nozzle 60 may be provided with a passage allowing communication between a cylindrical attachment port 62, which can be engaged with and attached to the outer peripheral portion of the front end 32, and a suction port 61, which is configured to be brought in contact with the work surfaces, such as a mat of a motor vehicle. A surface of the suction port 61, which may have an oval shape and be diagonally inclined with respect to the cylindrical attachment port 62, may generally define an opening surface. A plurality of projections 63 extending in a direction orthogonal to the opening surface of the suction port 61 are provided in a ring shape at equal distances around the suction port 61. The projections 63 may be made of an elastic material, such as rubber, and be configured to have substantially a conical shape.

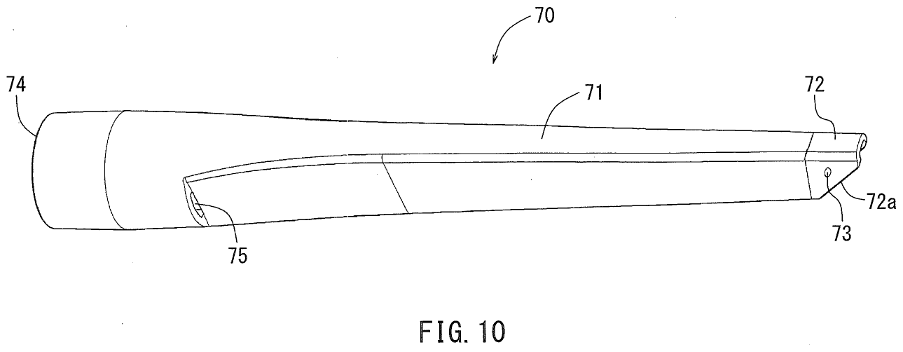

Hereinafter, an embodiment of a long sash nozzle 70 configured to be attachable to a front end 32 of a hose 30 will be described with reference to FIG. 10 to FIG. 16. The long sash nozzle 70 may be a rubber nozzle having moderate elasticity and may correspond to another further embodiment of an attachment connected to the hose 30. The long sash nozzle 70 comprises a pipe portion 71 elongated in a suction direction. The long sash nozzle 70 may be provided with an attachment port 74, having a cylindrical shape, at one end such that it can be engaged with and attached to the outer peripheral portion of the front end 32 of the hose 30. The long sash nozzle 70 may also be coupled with a nozzle 72, which may be made of a resin, at the other end. The nozzle 72 may be configured to be brought in contact with the work surface. A suction port 72a may be provided at the nozzle 72. A surface of the suction port 72a may have an opening surface diagonally inclined with respect to a pipe portion 71. One or more relief hole 75 is provided so as to pass through one or both of the left and right sides of the attachment port 74 side (downstream) of the pipe portion 71. The relief hole(s) 75 may be configured to serve as a suction opening when the suction port 72a is blocked by a working surface, etc., such that sufficient suction air generated by a fan 12 can be sustained and function as cooling air for cooling a motor 11 or a controller 18, so as to prevent a motor 11 and a controller 18 from overheating.

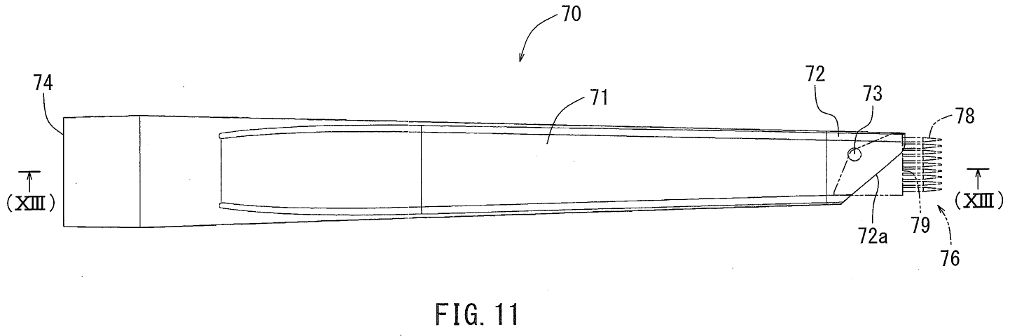

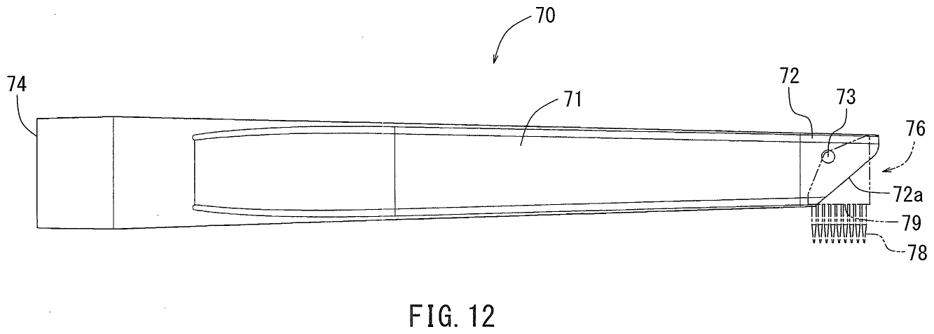

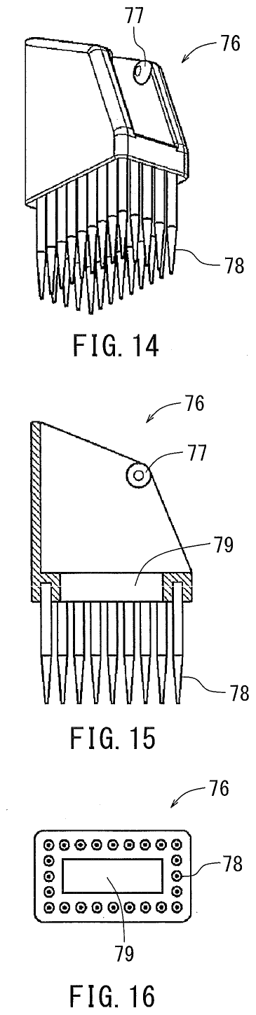

A separately provided brush attachment 76 may be removably attached to the nozzle 72. As shown in FIG. 10, attachment holes 73 may be provided in both the left and right sides of the nozzle 72, so as to be mutually coaxial with each other. As shown in FIG. 14 to FIG. 16, attachment protrusions 77 may be provided on the both left and right sides of the brush attachment 76, so as to be mutually coaxial with each other. The brush attachment 76 may be removably attached to the nozzle 72 by elastically engaging each of the attachment protrusions 77 with the respective left and right attachment holes 73. The brush attachment 76 may be selectively attached to the nozzle 72 in two orientations. The first orientation is, as shown in FIG. 11, an orientation such that the brush bristles 78 of the brush attachment 76 extend along the pipe portion 71 extending direction. In the first orientation, the surface of the suction port 79 may have an opening surface that is orthogonal to the pipe portion 71 extending direction. The second orientation, as shown in FIG. 12, is an orientation in which the brush bristles 78 of the brush attachment 76 are attached so as to extend in a direction orthogonal to the pipe portion 71 extending direction. In the second orientation, a surface of the suction port 79 may have an opening surface opening along the pipe portion 71 extending direction. The brush attachment 76 is configured to be rotated to the right or left so as to invert the brush attachment 76. The attachment brush 76 may then be attached to the nozzle 72 so as to optionally select the above first or second orientation.

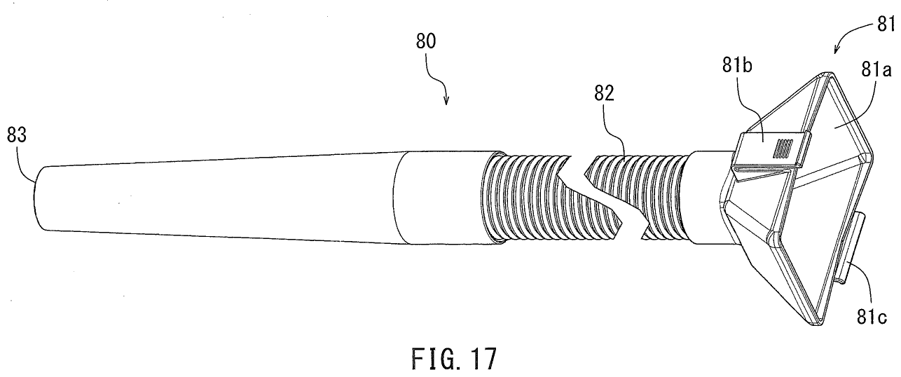

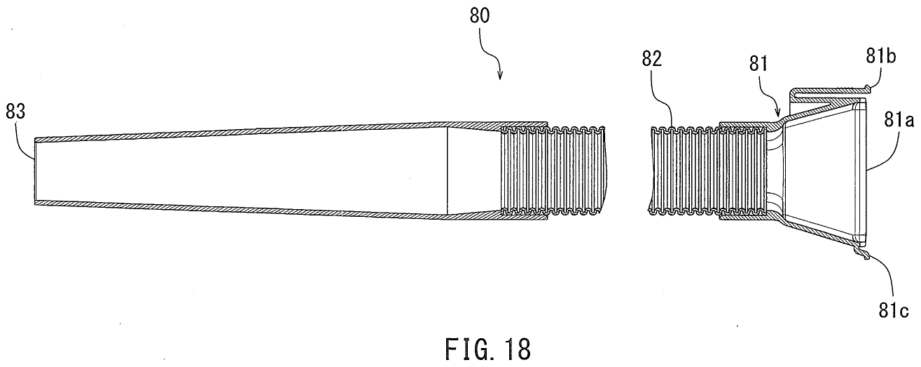

Hereinafter, an embodiment of a blower nozzle 80, which can be attached to the air outlets 10a of a main unit 10, will be described with reference to FIG. 17 and FIG. 18. The blower nozzle 80 may be provided with an attachment port 81a of an attachment portion 81 and an air outlet 83. The attachment port 81a can be attached to cover the entirety of the air outlets 10a. The attachment portion 81a may generally have a truncated quadrangular pyramid shape. The air outlet 83 may be in communication with the attachment port 81a via a bellow hose 82. As shown in FIG. 17 and FIG. 18, two hook claws 81b, 81c may be provided at the attachment portion 81. As shown in FIG. 17, the lower hook claw 81c may be provided to have a wider width than that of the upper hook claw 81b. Correspondingly, hook recesses 10b, 10c may be provided at the upper and lower sides of the air outlets 10a on a rear surface of the main unit housing 19. The lower hook recess 10c is formed to be longer in the left-right direction than the upper hook recess 10b. The attachment portion 81 may be attached to the main unit 10 to cover the air outlets 10a by engaging one hook claw 81b in the corresponding hook recess 10b and the other hook claw 81c in the other hook recess 10c. The air exhausted from the air outlets 10a of the main unit housing 19 flows through the bellow hose 82 and is exhausted from the air outlet 83 of the blower nozzle 80. Accordingly, the cleaner 1 may also serve as a blower used to blow dust, etc., away from the work surface utilizing this exhaust air.

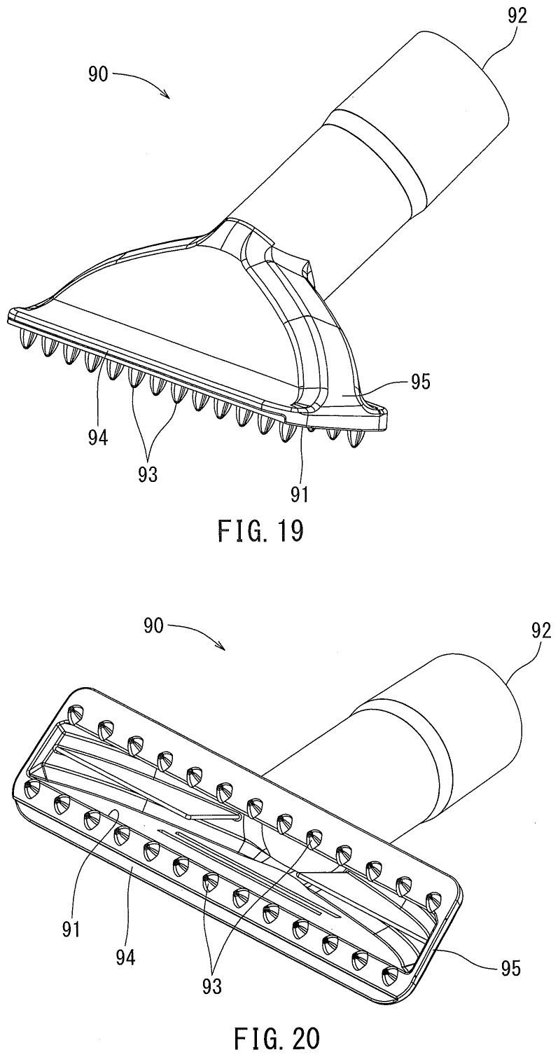

Hereinafter, an embodiment of a second mat nozzle 90 capable of being attached to the front end 32 of the hose 30 will be described with reference to FIG. 19 to FIG. 21. The mat nozzle 90 corresponds to another embodiment of an attachment connectable to the hose 30. As shown in FIG. 19 to FIG. 21, the mat nozzle 90 may be provided with a passage to allow communication between a cylindrical attachment port 92, which can be engaged with and attached to the outer peripheral portion of the front end 32, and a suction port 91, which comes in close contact with a work surface, such as a mat of a motor vehicle. The nozzle 95 formed with the suction port 91 may be formed to have a wide substantially rectangular shape in a plan view. The suction port 91 may open in a wide rectangular shape so as to conform to the shape of the nozzle 95. A plurality of projections 93 may be arranged in a row around the suction port 91 at substantially equal intervals along the longitudinal direction and along the outer peripheral portion of the suction port 91. The projections 93 may be made of, for example, resin and may have substantially a conical shape extending in a direction orthogonal to an opening surface of the suction port 91.

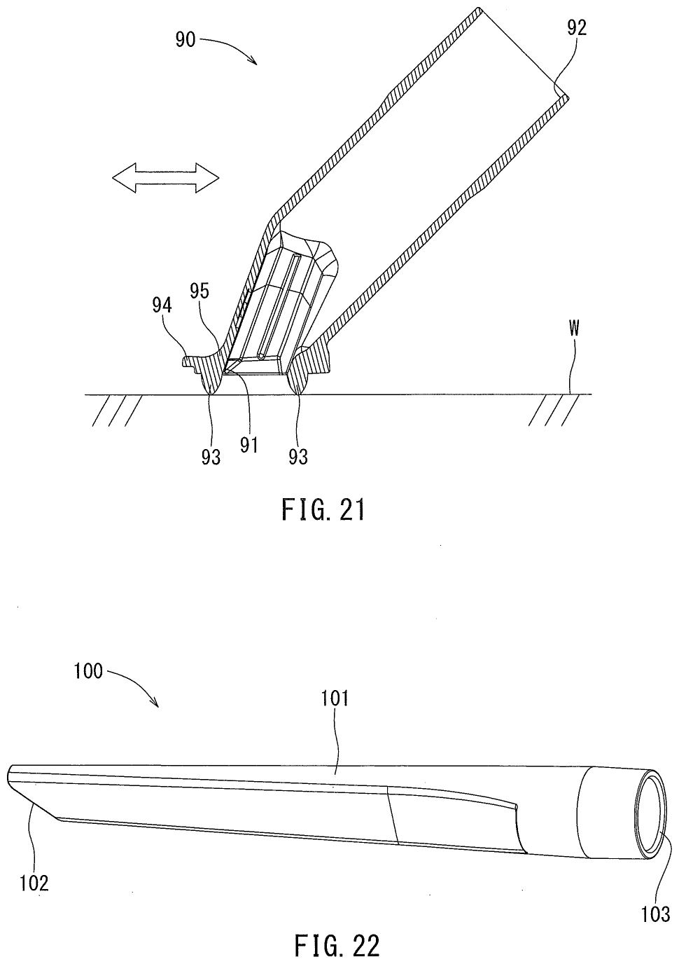

A protruding portion 94 may be provided at an outer edge of the nozzle 95. The outer peripheral edge of the nozzle 95 is located on an outer peripheral side of the nozzle 95 closer to the peripheral edge than the projections 93. The protruding portion 94 is disposed along a longitudinal direction and along the projections 93, which are arranged in a row, and extends outward from the outer edge of the nozzle 95. The protruding portion 94 may be disposed on one side of the outer peripheral side (left side in FIG. 21) so as to be positioned radially outward of the row of the projections 93, as shown in FIG. 21, or disposed on each of the outer peripheral sides so as to be positioned radially outward of both sides of the row(s) of projections 93 (not shown).

As indicated by a void arrow in FIG. 21, the mat nozzle 90 may be used by moving it with respect to the work surface, such as a mat of a motor vehicle, mainly in a direction orthogonal to the longitudinal direction of the suction port 91 (the left-right direction of FIG. 21). During work, the projections 93 project toward and/or into the work surface while the protruding portion 94 is positioned substantially parallel to the work surface. When the mat nozzle 90 moves along the work surface, for example, from left to right in FIG. 21, the mat or the like is released from the state in which the projections 93 are pressed thereto, so that rug tufts return to their original erected state. Absent the protruding portion 94, when the rug tufts bounce back to the erected state, adhered sand, dust, or the like may be scattered far away. However, when the mat nozzle 90 is provided with the protruding portion 94, sand, dust, etc. adhered to the rug tufts may be prevented from being scattered far away. For instance, the sand, dust, etc. particles may collided with the protruding portion 94, such that the dust is more likely to drop near the suction port 91, rather than being scattered far away. Cleaning efficiency can thereby be enhanced.

Hereinafter, an embodiment of a long rubber nozzle 100 configured to be attachable to the front end 32 of the hose 30 will be described with reference to FIG. 22. The long rubber nozzle 100 corresponds to another embodiment of an attachment connected to the hose 30. As shown in FIG. 22, the long rubber nozzle 100 may be provided with a passage to allow communication between a cylindrical attachment port 103, which can be engaged with and attached to the outer peripheral portion of the front end 32, and a suction port 102 configured to come in close contact with the work surface, such as a door pocket of a motor vehicle, via a pipe portion 101.

The long rubber nozzle 100 may be formed in one piece and made of an elastic material, such as rubber or the like. The long rubber nozzle 100 may be made of a high weatherproof, waterproof, and greaseproof synthetic rubber, such as, for example CR (chloroprene rubber) or NBR (nitrile rubber). The material may have a tensile strength of 5 to 25 MPa. The entire long rubber nozzle 100 may be made in one piece of a synthetic rubber, or the like, having a moderate rubber hardness. The entire long rubber nozzle 100 is not provided with a high hardness, and is different from the above-described long sash nozzle 70. The long rubber nozzle 100 may be deformed to correspond to a deeply recessed shape, such as a door pocket, while a flow path within the pipe portion 101 is hardly crushed. The pipe portion 101 is hardly crushed when being deformed because it has a high hardness. Further, the long rubber nozzle 100 may be, for example, made of gray rubber.

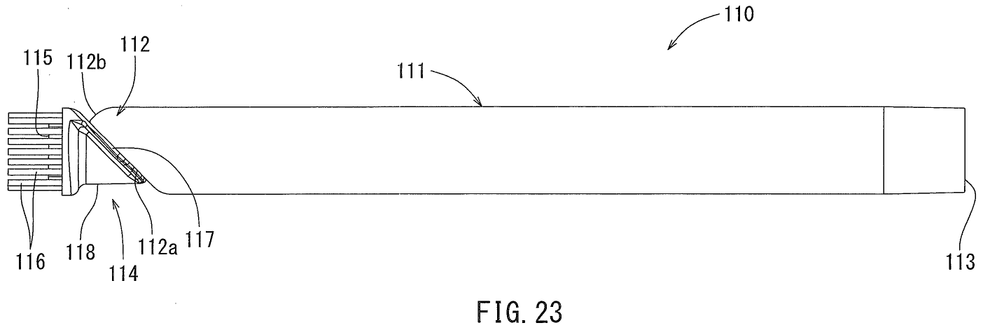

Hereinafter, an embodiment of an instrument panel nozzle 110 attachable to the front end 32 of the hose 30 will be described with reference to FIG. 23 to FIG. 28. The instrument panel nozzle 110 corresponds to another embodiment of an attachment connected to the hose 30. The instrument panel nozzle 110 may be used, for example, when cleaning the instrument panel of a motor vehicle. As shown in FIG. 23 to FIG. 28, a pipe portion 111 of the instrument panel nozzle 110 is made of, for example, a resin. The pipe portion 111 is elongated in a suction direction. A cylindrical attachment port 113, which can be engaged with and attached to the outer peripheral portion of the front end 32 of the hose 30, may be provided at one end of the pipe portion 111. A nozzle portion 112 made to approach the work surface may be formed integrally with the pipe portion 111 at the other end of the pipe portion 111. An attachment port 112a is provided at the nozzle portion 112. A surface inclined at about 45 degrees in a longitudinal direction of the pipe portion 111 generally defines an opening surface of the attachment port 112a. A corner 112b at the front end of the nozzle portion 112 may have a curved shape and may be configured such that the nozzle portion 112 is hardly caught when the nozzle portion 112 is advanced into a deeply recessed portion, such as an instrument panel.

As shown in FIG. 23 to FIG. 28, a separately provided brush attachment 114 may be provided at the attachment port 112a, so as to be rotatable about the axis of the attachment port 112a. The brush attachment 114 may be made of, for example, resin. The brush attachment 114 may have substantially a right triangle shape from a side view and may be provided with a passage extending between a surface corresponding to a diagonal side and a surface of the other side. The opening on the side of the surface corresponding to the diagonal side of the passage is an attachment port 117, which can be connected to the attachment port 112a. The surface corresponding to the other side of the passage is a suction port 115, which is configured to approach the work surface. The surface corresponding to one remaining side of the substantially right triangle in a side view, the side without an opening, is a wall portion 118. Brush bristles 116 extending in a direction opposite to the suction direction are arranged at substantially equal intervals along the outer peripheral portion of the suction port 115. A claw 117a, having moderate elasticity, which can be engaged with the attachment port 112a, may be provided at the outer edge of the suction port 117.

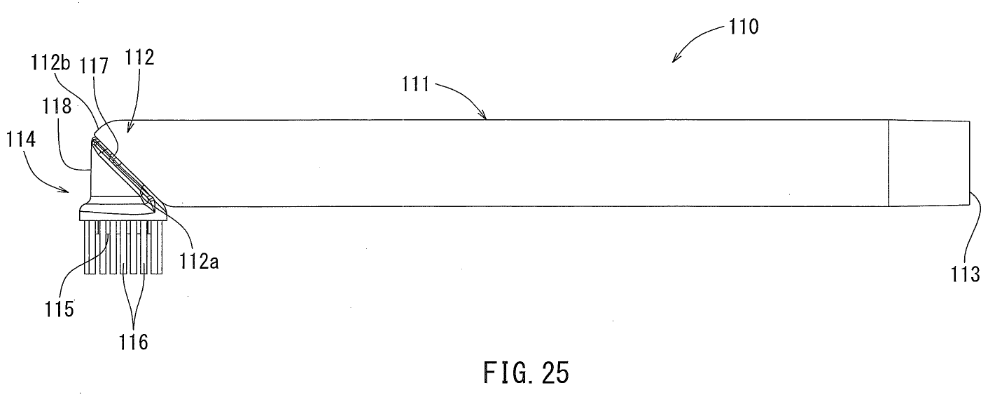

The brush attachment 114 may be attached to the attachment port 112a such that its orientation can be selectively changed between two orientations. As shown in FIGS. 23, 24, and 27, the first orientation is the orientation in which the brush bristles 116 extend along the longitudinal direction of the pipe portion 11. In the first orientation, the suction port 115 is opened so as to be oriented along the longitudinal direction of the pipe portion 111. As shown in FIGS. 25, 26, and 28, the second orientation is the orientation, in which the brush bristles 116 extend substantially orthogonal to the pipe portion 111 extending direction. In the second orientation, the suction port 115 is opened so as to be oriented along a direction substantially orthogonal to the longitudinal direction of the pipe portion 111. In the second orientation, a wall portion 118 is arranged on the extension in the longitudinal direction of the pipe portion 111. The orientation of the brush attachment 114 can be changed by rotating about the axis of the attachment port 112a to optionally select the first orientation or the second orientation, or any intermediate orientation therebetween.

The length of the instrument panel nozzle 110, from the attachment port 113 to the ends of the brush bristles 116 in the first orientation, may be, for example, equal to or more than 100 mm. The outer diameters of the pipe portion 111 and the brush attachment 114 in the first orientation may be, for example, equal to or less than 50 mm. The maximum height (e.g., the maximum height in a direction orthogonal to the longitudinal direction of the pipe portion 111 shown in FIG. 25) of the instrument panel nozzle 110, from the nozzle portion 112 to the ends of the brush bristles 116 in the second orientation, may be, for example, equal to or less than 70 mm.

According to the cleaner 1 of the present embodiment as described above, the rotational degree(s) of freedom of the hose 30 at the connecting portion 31 may be enhanced, as the hose 30 and the main unit 10 are connected via a connecting portion 31 having a ball-joint type configuration, the connecting portion 31 being configured with a ball portion 31a and a ball receiving portion 31b. Therefore, since a load, such as a torsional or bending force, applied to the hose 30 at the connecting portion 31 can be reduced when the hose 30 is wound around the main unit 10, the hose 30 is hardly damaged, even when the hose 30 is wound around the main unit 10 in a compact manner. Further, according to the cleaner 1 of the present embodiment, at least one part of the hose 30 between the connecting portion 31 and the front end 32 is held by the hose holding portion 14, when the hose 30 is wound around the main unit 10. The hose 30 can therefore be wound around the main unit 10 to be held in a compact manner.

Further, according to the cleaner 1 of the present embodiment, the hose 30 can be wound so as to be more easily held, since the axis of the hose 30 (hose axis J2) at the connecting portion 31 is inclined with respect to the axis of the motor shaft 11a (motor axis J1) of the motor 11. Moreover, the length of the main unit 10 in an axial direction of the motor shaft 11a (front-rear direction) may be shortened. Furthermore, according to the cleaner 1 of the present embodiment, the hose 30 may be stored in a compact manner by being held around the hose holding portion 14 toward the front part of the main unit 10. This allows the cleaner 1 to be easily transported with the hose 30 wound around the main unit 10. Also, according to the cleaner 1 of the present embodiment, the connecting portion 31 and the front end 32 of the hose 30 may be arranged side-by-side, in a left-right direction, and held by the main unit 10. This allows the hose 30 to be held in a compact and well-balanced manner in the left-right direction.

Further, according to the cleaner 1 of the present embodiment, an attachment suitable for cleaning a spot may be quickly attached to the front end 32 of the hose 30. Further, the attachment suitable for cleaning the spot can be quickly stored by the attachment storage 15 of the main unit 10.

Further, according to the cleaner 1 of the present embodiment, dust adhered to seats, etc., of a motor vehicle can be effectively inhaled into the suction port 51 while being swept out by the lint brushes 53 of the seat nozzle 50. Furthermore, according to the cleaner 1 of the present embodiment, dust accumulated in small gaps, for example, seams and grained grooves of a motor vehicle, that were not swept out with the lint brushes 53 can be swept out with the auxiliary brushes 54.

Further, according to the cleaner 1 of the present embodiment, a location with adhered dust, for example a mat of a motor vehicle, may be surrounded by the plurality of the elastic projections 63 when the suction port 61 of a mat nozzle 60 comes in contact with this location. Accordingly, stronger suction air flows through the narrow gaps between the plurality of the elastic projections 63, as well as between the location to be cleaned and the suction port 61 end face. This allows the dust to be inhaled into the suction port 61 with the strong suction air.

Further, according to the cleaner 1 of the present embodiment, the pipe portion 71 of the long sash nozzle 70 is made of an elastic material (e.g., rubber). This allows the suction port 72a of the long sash nozzle 70 to reach narrow and intricate locations, such as end portions of door handles or a windshield of a motor vehicle. Thereby, locations that were normally difficult to clean can be cleaned using the long sash nozzle 70. Moreover, according to the cleaner 1 of the present embodiment, locations with small components, such as an instrument panel, etc., of a motor vehicle, can be cleaned by attaching the separately provided brush attachment 76 to the nozzle 72 of the long sash nozzle 70. Furthermore, according to the cleaner 1 of the present embodiment, the suction angle of the suction port 79 of the brush attachment 76 with respect to the nozzle 72 may be changed in accordance with the locations to be cleaned. It can accordingly be adapted to clean intricate locations.

Further, according to the cleaner 1 of the present embodiment, it is possible to add a blower function to the cleaner 1 by feeding and injecting the exhaust air exhausted out of the air outlets 10a, into an attachment portion 81 of a blower nozzle 80, and out an air outlet 83 via a bellow hose 82. Thereby, the convenience of the cleaner 1 is enhanced.

Further, according to the cleaner 1 of the present embodiment, since the protruding portion 94 is provided around the mat nozzle 90, dust scattered due to the restoration of the tufts of a mat, etc. to their original state is prevented from being scattered far away. Instead, the dust collides with the protruding portion 94, such that the scattered dust may more likely drop near the suction port 91. Cleaning efficiency can thereby be enhanced.

Further, according to the cleaner 1 of the present embodiment, the long rubber nozzle 100 may be made in one piece and of a synthetic rubber, or the like, having a moderate rubber hardness. Therefore, the suction port 102 is allowed to reach a deeply recessed spot, such as a door pocket, because the long rubber nozzle 100 is deformable. Additionally, the flow path within the pipe portion 101 can be ensured while the suction port 102 reaches the deeply recessed spot. Furthermore, according to the cleaner 1 of the present embodiments, the long rubber nozzle 100 may be made of, for example, gray rubber. Grey rubber makes scratch marks, for instance cause when the suction port 102 of the long rubber nozzle 100 enters a deeply recessed spot such as a door pocket or the like, on white or black interior materials less noticeable.

Further, according to the cleaner 1 of the present embodiment, the instrument panel nozzle 110 may be oriented in both a first posture, in which the brush bristles 116 extend along the longitudinal direction of the pipe portion 111, and a second posture, in which the brush bristles 116 extend in a direction substantially orthogonal to the pipe portion 111 extending direction. This makes it possible to clean, for example, an instrument panel of a motor vehicle, by properly adopting the suitable first orientation or second orientation. This allows cleaning of intricate locations, such as an instrument panel, etc. Further, according to the cleaner 1 of the present embodiments, a corner at the front end of the nozzle portion 112 may have a curved shape. Therefore, the nozzle portion 112 is hardly caught when the nozzle portion 112 is advanced into a deeply recessed portion, such as an instrument panel, etc. of a motor vehicle, thereby enhancing usability.

Various modifications may be made to the above-described cleaner 1 according to the present embodiment. For example, an appropriate modification may be made to a wound position or held position of the hose 30 around or to the main unit 10, without being limited by the present embodiment. Further, a rechargeable battery different from a lithium ion battery of the cleaner 1 of the present embodiment may be used for the battery 41. An arrangement of the elastic projections 63 provided on the mat nozzle 60 or an arrangement of the projections 93 provided on the mat nozzle 60 shall not be limited to those described in the present embodiment. For example, it is not necessary to satisfy all conditions of the arrangement of the elastic projections 63 or the projections 93 of the cleaner 1 of the present embodiments. They may be simply arranged at equal intervals, simply arranged to form a curve, simply arranged to form an annular shape, etc. The type and/or shape of the blower nozzle 80 shall not be limited to those described in the present embodiment. The blower nozzle 80 may be provided so as to be held at the main unit 10. A plurality of attachments may be provided so as to be held by the main unit 10. The elastic projections 63 of the mat nozzle 60 or the pipe portion 71 of the long sash nozzle 70 or the long rubber nozzle 100, etc., shall not be limited to those made of rubber, as illustrated in the present embodiments. Other elastic members may also be used.

1. A cleaner, comprising:
a motor;
a fan rotated by the motor;
a main unit for accommodating the motor and the fan; and
a hose as a flow passage for suction air generated by the fan into the main unit,
wherein:
the hose and main unit are connected to each other at a connecting portion via a ball joint,
the hose is provided such that the hose is configured to be wound around the main unit, and
at least one part between the connecting portion and a front end of the hose is held by the main unit in an attachable/removable manner.

2. The cleaner according to claim 1, wherein an axis of the hose at the connecting portion is inclined with respect to an axis of a motor shaft of the motor.

3. The cleaner according to claim 1, wherein the hose is configured to be stored with the hose wound around the main unit ahead of the fan.

4. The cleaner according to claim 3, wherein the front end of the hose is stored by being held by the main unit in a position side-by-side with the hose at the connecting portion.

5. The cleaner according to claim 1, wherein:
an attachment is configured to be attached to the front end of the hose, and
the attachment is configured to be removed from the front end of the hose and stored by the main unit.

6. The cleaner according to claim 5, wherein the attachment is provided with:
a brush surface provided at a suction port end face of the attachment, and
an auxiliary brush provided on an outside of the attachment and located at a place corresponding to a downstream suction air side of the brush surface.

7. The cleaner according to claim 5, wherein:
the attachment is provided with a plurality of projections at a suction port end face of the attachment,
the plurality of projections extend in a direction opposite to a suction direction of the suction air, and
the plurality of the projections are aligned with one another on the suction port end face.

8. The cleaner according to claim 5, wherein:
the attachment is a nozzle having an extended form in the suction direction of the suction air,
a front end of the nozzle is provided with a brush, and
the brush is rotatably attached to the nozzle.

9. The cleaner according to claim 1, wherein:
a blower nozzle having a hose-shape is configured to be attached to or removed from an air outlet of the main unit, and
the cleaner is configured to serve as a blower when the blower nozzle is attached to the air outlet of the main unit.

10. The cleaner according to claim 2, wherein the axis of the hose at the connecting portion is inclined with respect to the axis of the motor shaft when the part between the connecting portion and the front end of the hose is held by the main unit.

11. The cleaner according to claim 2, wherein the hose at the connecting portion overlaps another portion of the hose in a direction parallel to a direction perpendicular to the axis of the motor shaft when the part between the connecting portion and the front end of the hose is held by the main unit.

12. The cleaner according to claim 1, wherein the ball joint comprises:
a ball portion, and
a ball receiving portion.

13. The cleaner according to claim 12, wherein an angle between an axis of the ball receiving portion and an axis of a motor shaft of the motor is less than an angle between an axis of a front end storage portion configured to store the front end and the axis of the motor shaft.

14. The cleaner according to claim 12, wherein an axis of the ball receiving portion is more inclined with respect to an axis of a motor shaft of the motor than an axis of the ball portion with respect to the axis of the motor shaft, when the part between the connecting portion and the front end of the hose is held by the main unit.

15. A cleaner, comprising:
a motor;
a fan rotated by the motor;
a main unit for accommodating the motor and the fan; and
a hose as a flow passage for suction air generated by the fan into the main unit, the hose being connected to the main unit via a ball joint, wherein:
the hose comprises a first portion extending upward from the ball joint and a second portion extending downward from the first portion via a bending portion, an angle between a first extending direction of the first portion and a second extending direction of the second portion is less than 90 degrees.

16. The cleaner according to claim 15, wherein:
the ball joint comprises a ball portion connected to the hose and a ball receiving portion configured to rotatably support the ball portion, and
the second portion of the hose extends parallel to an axis of the ball receiving portion.

17. The cleaner according to claim 15, wherein:
the ball joint comprises a ball portion connected to the hose and a ball receiving portion configured to rotatably support the ball portion, and
an axis of the ball portion of the ball joint and an axis of the ball receiving portion are both inclined with respect to an axis about which the fan rotates.

18. The cleaner according to claim 15, wherein the main unit includes a holding portion configured to hold a portion of the hose, wherein the holding portion includes a groove extending right-left direction and a holding bar extending vertically in front of the groove.

19. The cleaner according to claim 15, wherein the main unit includes a holding portion configured to hold a portion of the hose, wherein the holding portion and the ball joint are arranged vertically each other.

20. The cleaner according to claim 15, wherein the main unit includes a holding portion configured to hold a held portion of the hose, wherein the held portion extends non-parallel to an axis about which the fan rotates.
